(19) United States
(12) Patent Application Publication
(10) Pub. No.: US 2015/0068250 A1
(43) Pub. Date: Mar. 12, 2015

(54) METHOD FOR PRODUCING FLOAT GLASS

(71) Applicants: Kamil Alimovich Ablyazov, Saratov (RU); Aleksandr Borisovich Zhimalov, Saratov (RU); Vladimir Pavlovich Chalov, Bor (RU)

(72) Inventors: Kamil Alimovich Ablyazov, Saratov (RU); Aleksandr Borisovich Zhimalov, Saratov (RU); Vladimir Pavlovich Chalov, Bor (RU)

(21) Appl. No.: 14/391,145

(22) PCT Filed: Mar. 15, 2013
(86) PCT No.: PCT/RU2013/000200

§ 371 Date: Oct. 7, 2014

(30) Foreign Application Priority Data
Apr. 23, 2012 (RU) 2012116384

(51) Int. Cl. C03B 35/14; C03B 25/093; C03B 18/02

(52) U.S. Cl. CPC C03B 35/147; C03B 18/02; C03B 25/093; C03B 2225/00
USPC 65/25.3

(57) ABSTRACT

The invention relates to a method for producing glass on a metal melt and can be used for improving the quality of float glass. The invention makes it possible to increase the quality of the lower surface of the float glass by removing micro-defects. To do this, a glass strip is raised above draw-in shafts of a slag chamber and kept in a raised position during transport in the slag chamber area by reducing the atmospheric pressure above the glass strip in relation to the pressure acting on the glass strip from below.

### TECHNICAL FIELD

The present invention relates to a method for producing float glass and may be used to improve the float glass quality.

### BACKGROUND ART

Modern float glass technologies demand higher quality of the output product, and more specifically zero defect level and higher glass surface strength.

In the process of float glass manufacturing the glass ribbon which is shaped and cooled to 650°-600° C. is pulled out from the float bath and fed to the annealing furnace shafts by receiving shafts of a slag chamber. The chamber is designed to protect the float bath discharge opening as the glass ribbon is raised to roller table shafts from penetration of acidifying molten tin oxygen alloys and sulfides and also to provide required thermal and physic-mechanical conditions for the glass ribbon transfer from molten tin surface to metal rollers. Receiving shafts of the slag camber and annealing furnace are radially installed to provide balanced weight distribution when the glass ribbon is moved from the float bath to roller table shafts. Temperature of slag chamber receiving shafts ranges from 500° to 560° C., so the contact of a hot glass ribbon with cooler shafts surface causes micro defects—surface cracks, scratches, etc. Moreover micro defects of the lower float glass surface—roller marks, grazes—may appear as a consequence of tin oxide crust adhesion to the shafts surface. It may happen because in spite of the slag chamber a small amount of oxygen penetrates into the float bath through the discharge opening while the glass ribbon is raised from the molten tin surface because the open surface of molten tin is rather big which leads to accumulation of sufficient amount of tin oxides on the molten tin surface under the glass ribbon. Some part of tin oxides is deposited on the lower surface of the glass ribbon raised above the molten tin, and then carried out of the float bath and adhered to the shafts surface in the form of a solid crust. All this results in deterioration of the lower glass surface quality.

In order to improve the quality of the lower float glass surface different ways to reduce its defectiveness have been proposed. Mainly they relate to different constructive options of roller table shafts location in a slag chamber and annealing furnace to reduce the outflow of tin oxides from the float bath and its adhesion to the roller table shafts.

Pat. No. GB 1017752 IPC C03B 18/00 discloses a method of multistage lifting of the front roller table shafts of the annealing furnace to improve the quality of the float glass surface. In order to improve the quality of float glass in Pat. No. RF2302380 IPC C03B 18/00 the glass ribbon is drawn out of the float bath and transported over the shafts of the annealing furnace with a bend which results from successive lifting of the shafts in a slag chamber and annealing furnace and subsequent smooth lowering of annealing furnace shafts to the level of float bath exit sill. The method of pulling the glass ribbon allows to reduce the lifting height of a glass ribbon in a float bath and thereby reduce the open surface area of molten tin under the glass ribbon and improve the quality of the lower glass surface. The main drawback of the claimed methods is that the quality of the lower glass surface improves insignificantly as proposed constructive solutions may not provide a significant decrease in adhesion of tin oxide on the shafts surface and thus prevent formation of roll marks, cracks, small chippings on the lower glass surface.

In order to effectively reduce defectiveness of the lower glass surface different methods of float glass manufacturing using gas hearth systems have been proposed.

Thus, Pat. No. DE 102004059727 IPC C03B 32/00 discloses method and apparatus for noncontact holding and transportation of the glass ribbon on a gas hearth bed with a uniform pressure and temperature distribution. The main drawback of the proposed method is complexity of its implementation.

The closest to the claimed method is a method for float glass manufacturing disclosed in a.c. No. 299470 IPC C03B 18/02. At the 1^{st} stage the glass ribbon is formed in a float bath at the temperature ranging from 850° to 750° C., the 2^{nd} stage takes place in temperature-controlled chamber of a gas hearth system, and then the glass ribbon is fed to a pulling device—annealing furnace shafts.

A considerable part of the glass ribbon curing portion is moved from a molten metal surface to a gas hearth bed which leads to significant reduction of the cooling zone in a float bath where the process of molten tin oxidation takes place intensively. Moreover, the glass ribbon is transported from a gas hearth system to the annealing furnace shafts horizontally which also contributes to defectiveness reduction of the lower float glass surface.

Drawback of the proposed method is feed gas differential across the gas hearth system, channel clogging in a gas hearth system which causes glass ribbon deformation.

### DISCLOSURE OF INVENTION

The object of the present invention is to improve the quality of the lower float glass surface. The technical result of the present invention is to eliminate micro defects of the lower float glass surface caused by the receiving slag chamber shafts.

The task is achieved by a method for producing float glass, comprising glass melting, molten glass discharge into a float bath and glass ribbon forming on the molten metal surface, while the glass ribbon is being transported from the float bath by receiving slag chamber shafts and annealing furnace shafts it is kept in a raised position during transport in a slag chamber area by reducing the atmospheric pressure above the glass ribbon in relation to the pressure acting on the glass ribbon from below. Atmospheric pressure above the glass ribbon in the area of receiving slag chamber shafts is reduced by an amount to allow raising the glass ribbon above the receiving shafts and its keeping above them during transportation. Atmospheric pressure reduction above the glass ribbon in the area of receiving slag chamber shafts is performed by one or more pumping devices connected to a vacuum system. Glass ribbon lifting above the receiving shafts of the slag chamber is restricted by local air/gas mixture pressurizing to the upper glass ribbon surface performed by the pumping devices. The decrease in atmospheric pressure above the glass ribbon in a slag chamber is created by a combination of air/gas mixture pumping and local pressurizing.

Glass ribbon transfer from the molten metal in a float bath to the annealing furnace shafts avoiding contact with slag chamber shafts significantly increases the quality of the lower glass surface by reducing defects related to the contact of the glass ribbon with receiving slag chamber shafts surface such as cracks, small chippings and roll marks.

### BRIEF DESCRIPTION OF THE DRAWINGS

The inventive method is illustrated by the following drawings:

FIG. 1 is a schematic general view of the present invention, where: 1—glass furnace, 2—float bath, 3—molten tin, 4—glass ribbon, 5—receiving slag chamber shafts, 6—slag chamber, 7—vacuum generator above the glass ribbon, 8—annealing furnace shafts, 9—annealing furnace.

FIG. 2 is a schematic representation of forces distribution applied to the float glass ribbon, where: 4—glass ribbon, 5—receiving shafts of a slag chamber, 7—vacuum generator above the glass ribbon.

P is glass ribbon gravity in the vacuum area in a slag chamber.

F₁, F₂ are forces applied to the glass ribbon as it is pulled by the roller table shafts and opposed to the glass ribbon center line.

FIG. 3 is a schematic representation of forces distribution applied to the raised portion of a glass ribbon, where: 4—glass ribbon, 5—receiving slag chamber shafts, 7—vacuum generator above the glass ribbon.

P is glass ribbon gravity in the vacuum area in a slag chamber.

F₁, F₂ are forces applied to the glass ribbon as it is pulled by the roller table shafts and opposed to the glass ribbon center line.

F₃ is a resulting pulling force created when the glass ribbon is raised and kept in this position in the vacuum area in a slag chamber.

F₄ is a force created in the vacuum area in a slag chamber.

FIG. 4 is a schematic view of the inventive method comprising local air pressurizing, where: 2—float bath, 3—molten tin, 4—glass ribbon, 5—receiving slag chamber shafts, 6—slag chamber, 7—vacuum generator above the glass ribbon, 8—annealing furnace shafts, 9—annealing furnace, 10—unit for local air/gas mixture pressurizing to the upper glass ribbon surface.

### EMBODIMENTS

The present invention is illustrated by the following examples.

### Example 1

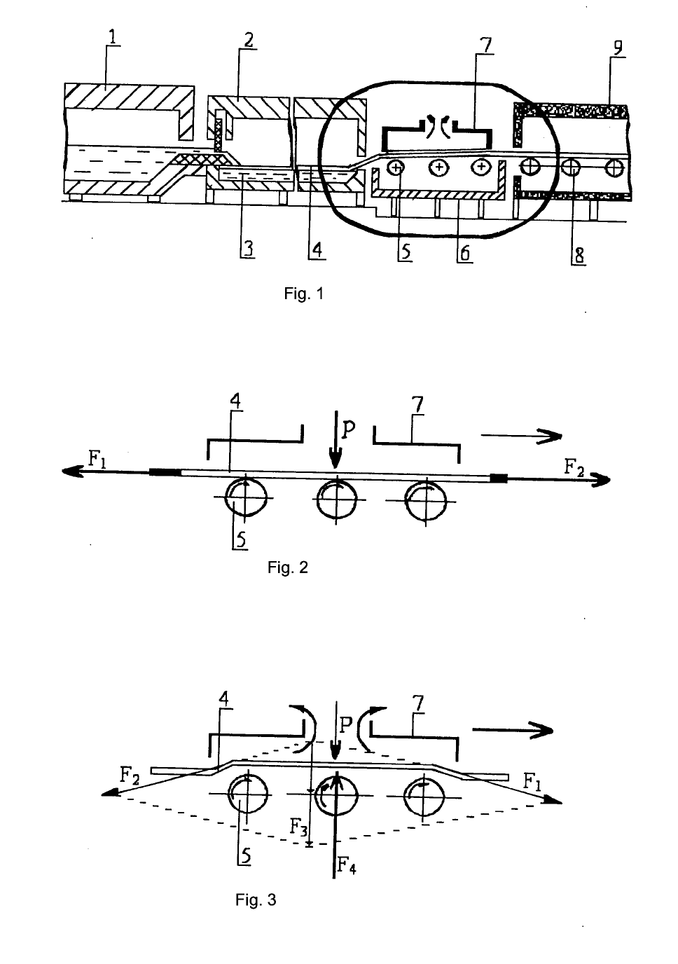

Molten glass from a glass furnace 1 is fed into the float bath 2 filled with gas-proof atmosphere on the molten tin surface 3 where the glass ribbon 4 is formed. Then the glass ribbon is fed to the receiving slag chamber shafts 5. Slag chamber comprises two independent parts: the lower part 6 and the upper part 7, comprising vacuum generator above the glass ribbon. After the slag chamber the glass ribbon is transported to the annealing furnace shafts 8 and enters annealing furnace 9 (FIG. 1).

While the glass ribbon is transported by the slag chamber shafts a part of the glass ribbon in the slag chamber is affected by gravity P of the glass ribbon as well as pulling forces F₁ and F₂ which are equilibrant (FIG. 2).

Unit 7 is positioned above the glass ribbon 4 in a slag chamber 6, it includes several blocks comprising ducts for air pumping from the space between the duct and the glass ribbon. The number of ducts is chosen so that they provide uniform air/gas mixture pumping across the glass ribbon and along the vacuum area.

In the 1^{st} experiment ducts for air/gas mixture pumping were used. Concurrent operation of all the air pumping ducts with capacity of 20,000 m3/h allowed to raise the part of a glass ribbon above the shafts 5 in the lower part of the slag chamber, whereas the lower air gap between the glass ribbon and the shafts ranges from 3 mm to 10 mm and the upper air gap between the lower duct surface and the upper glass ribbon surface ranges from 0.5 mm to 3 mm. Intensity and stability of the air/gas mixture pumping was controlled by the dampers installed in the ducts. Part of the glass ribbon was raised above the slag chamber shafts 5 and kept in this position by the forces affecting the glass ribbon as long as vacuum was generated.

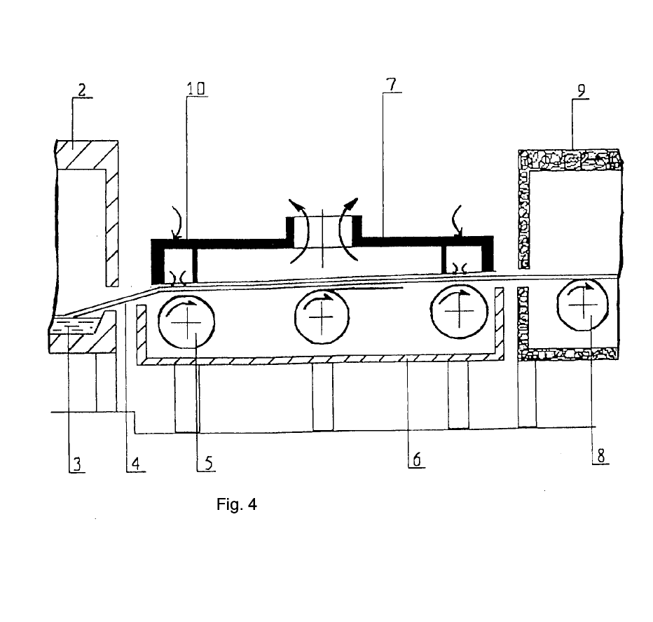

When the part of the glass ribbon is raised above the moving level pulling forces F₁ and F₂ on both sides of the lifted part of the glass ribbon change their direction from horizontal downwards and generate a resulting force F₃ directed straight downwards which prevents lifting the part of the glass ribbon 4 (FIG. 3).

Force F₃ increases with lifting of the part of the glass ribbon 4. Part of the glass ribbon 4 is lifted by the unbalanced to the atmospheric pressure force F₄ which is directed upwards and created in the process of vacuum generation.

When the glass ribbon is transported a part of the glass ribbon 4 is raised above the receiving slag chamber shafts 5 and kept in a raised position when the forces are balanced according to the formula: F₄=P+F₃.

After the vacuum area the glass ribbon was transported to annealing furnace shafts 8 in the annealing furnace 9, and at the final stage the glass ribbon was cut and samples of glass were selected. Moreover, before the experiment there had been selected reference glass samples.

Quality monitoring of the lower surface micro defects was performed by visual means. The lower surface glass strength was estimated by the plate flexure test. Sample analysis showed significant reduction of mechanical lower surface defects and strength increase by a factor of 1.4.

### Example 2

Float glass manufacturing process is similar to the one described in example 1. In the 2^{nd} experiment in addition to all operating air pumping ducts (with capacity 20,000 m3/h) air/gas mixture was pressurized locally to the upper glass ribbon surface to regulate the upper air gap and keep the glass ribbon above the roller table shafts. Air pressurizing is performed by an air pressurizing apparatus with capacity of 6,000 m3/h.

Glass ribbon 4 is transported from the float bath 2 filled with molten tin 3 to a slag chamber 6, where the glass ribbon is raised above the slag chamber shafts 5 by an apparatus 7 comprising a unit for air/gas mixture pumping and additional unit for air pressurizing with capacity of 6,000 m3/h.

Part of a glass ribbon in experimental area was raised and kept above the shafts 5 of a slag chamber 6 at a height varying from 3 mm to 10 mm, the upper air gap between the apparatus 7 and upper glass ribbon surface 4 ranges from 0.5 mm to 3 mm. Local air pressurizing is mainly required when the glass ribbon is raised and the air pumping mode is realized as it is less likely that the upper glass ribbon surface 4 may adhere to the lower surface of apparatus 7, and it also contributes to consistent equipment performance.

After the vacuum area the glass ribbon was moved to the annealing furnace shafts 8 in the annealing furnace 9, and at the final stage the glass ribbon was cut and samples of glass were selected for analysis.

Quality monitoring of the selected samples lower surface as well as reference samples quality monitoring was performed similar to experiment 1. Sample analysis also showed significant reduction of mechanical lower surface defects and strength increase by a factor of 1.4.

Embodiments of the present invention in examples 1 and 2 do not restrict the scope of the invention as defined by the claims and detailed description of the present invention.

1.-5. (canceled)

6. A method for producing float glass, comprising the steps of:
melting an amount of glass to form an amount of molten glass;
discharging the molten glass into a float bath and forming a glass ribbon on a molten metal surface;
transporting the glass ribbon from the float bath through a receiving slag chamber shaft and an annealing furnace shaft;
wherein the glass ribbon is raised above a surface of the receiving slag chamber shaft and kept in that position during transport in a slag chamber area by reducing an atmospheric pressure above the glass ribbon in relation to a pressure acting on the glass ribbon from below.

7. The method according to claim 6, wherein the atmospheric pressure above the glass ribbon in an area of the receiving slag chamber shaft is reduced by an amount so as to allow raising the glass ribbon above the receiving slag chamber shaft and keeping the glass ribbon in a raised position during the transportation step.

8. The method according to claim 6, wherein the atmospheric pressure reduction above the glass ribbon in the area of the receiving slag chamber shaft is performed by one or more pumping devices connected to a vacuum system.

9. The method according to claim 8, wherein the lifting of the glass ribbon above the receiving slag chamber shaft of the slag chamber is restricted by a local air/gas mixture pressurizing the upper glass ribbon surface that is performed by the pumping devices.

10. The method according to claim 9, wherein the decrease in atmospheric pressure above the glass ribbon in the slag chamber is created by a combination of the air/gas mixture pumping and local pressurizing.
